(19) United States
(12) Patent Application Publication
(10) Pub. No.: US 2006/0103154 A1
(43) Pub. Date: May 18, 2006

(54) Emergency mobile sleep units

(76) Inventor: C. Glen Berry, Bentonville, AR (US)

Correspondence Address: THE INVENTORS NETWORK, INC., 332 ACADEMY STREET, CARNEGIE, PA, 15106, US

(21) Appl. No.: 11/319,713

(22) Filed: Dec. 29, 2005

Related U.S. Application Data
(63) Continuation-in-part of application No. 10/731,388, filed on Dec. 10, 2003.

(51) Int. Cl. B60P 3/00

(52) U.S. Cl. 296/24.39

(57) ABSTRACT

An emergency mobile sleeping unit transportable from site to site by tractor-trailer, railway, airlift, or by water includes a tractor-trailer unit modified to create sleeping quarters and an office and workstation usable by a number of individuals. The sleeping unit can be in a number of different configurations each of which can include several rows of flip up sleeping bunks attachable to the sidewalls of the unit and that can be opened for use and folded up to open the interior of the unit when the bunks are not in use, an office and bunk area that can include storage drawers, a countertop, a refrigerator, a microwave oven, wall-hung storage cabinets, water coolers, a generator cabinet for storage of a diesel-fired portable generator, and telecommunications ports, connections and equipment. Pop-out escape windows are located adjacent each flip up bunk to provide quick exit when necessary from the mobile sleeping unit.

This application is a continuation-in-part application of application Ser. No. 10/731,388 filed on Dec. 10, 2003.

### FIELD OF THE INVENTION

The present invention pertains to mobile sleeping units, and more particularly pertains to mobile sleeping units that can be transported to the site by roadway, railway, helicopter, ship or airplane.

### BACKGROUND

The invention involves a mobile sleeping unit, designed to provide temporary accommodations for large numbers of people. During emergency situations, it is often necessary to provide for displaced persons and for emergency workers. For example, during a large forest fire, it is necessary to bring in hundreds of firefighters and other emergency personnel. These persons may be on duty for many days, with little access to adequate shelter, food and sleeping facilities. In another example, after a hurricane or tornado, there may be a large number of persons displaced from their homes. In addition, there will be Red Cross and other emergency aid people brought in to provide assistance. In many areas, there is simply not enough hotels or other accommodations available to house these people.

Currently, shelter during emergencies must be provided by hotels, tents or prefabricated buildings, constructed on-site. These have obvious disadvantages. Existing accommodations, such as hotels, may be nonexistent or too far away. Tents do not provide a significant shelter from weather or extreme temperatures. Prefabricated buildings, such as those disclosed in U.S. Pat. No. 4,603,518, have been used. However, these types of structures are not very portable, and can be expensive to move and set up. Other types of mobile accommodations are available, in the form of recreational vehicles, buses and campers. These types of systems have been described in the prior art, notably U.S. Pat. Nos. 2,231,822, 4,759,582 and 6,017,080. However, these accommodations are not suitable to emergency use because they are typically not designed for off-road or heavy-duty usage.

A better solution would be low cost housing which can be easily moved by truck, helicopter or other means, provides significant protection from weather, has heating and air conditioning, and provides kitchen facilities integrated with the sleeping facilities.

### SUMMARY OF THE INVENTION

In one embodiment, the present invention is directed to a mobile sleeping unit with a vehicle chassis and body. The chassis includes a coupling device to attach to a towing vehicle and wheels to move the unit along roads. The body includes an access door, sleeping bunks, kitchen and storage facilities, lighting, ventilation and electricity.

In another embodiment, the present invention is directed to a mobile sleeping unit in which the unit is constructed from a standard 28-foot tractor-trailer.

### BRIEF DESCRIPTION OF THE DRAWINGS

FIG. 1 is a side elevational view of one embodiment of the present invention, attached to a tractor-trailer truck for transportation;

FIG. 2 is a cut view of the inside front portion of the embodiment shown in FIG. 1, showing the kitchen and storage facilities, and the air conditioning unit;

FIG. 3 is a cut view of the inside sidewall of the embodiment shown in FIG. 1, showing the sleeping quarters;

FIG. 4 is a perspective view of the embodiment shown in FIG. 1;

FIG. 5 is a perspective view of an alternative embodiment for the emergency mobile sleeping unit of the present invention that is attachable to a tractor-trailer truck;

FIG. 6 is a top plan view of the alternative embodiment for the emergency mobile sleeping unit of the present invention illustrating the arrangement of the general sleeping quarters and the office and bunk area and furnishings and amenities located therein;

FIG. 7 is a side elevational view of the alternative embodiment for the emergency mobile sleeping unit of the present invention illustrating the arrangement of several rows of sleeping bunks, adjacent safety ladders and egress windows, and the office and bunk area; and

FIG. 8 is a perspective view of the alternative embodiment for the emergency mobile sleeping unit of the present invention illustrating the office and bunk area, the upper and lower double coat closet, the work station, the refrigerator and microwave oven, and the roll-out generator cabinet housing therein the generator.

### DETAILED DESCRIPTION

The present invention is directed to a mobile sleeping unit. In the embodiment shown on the figures, the invention utilizes readily available vehicles and equipment to create a unit that can be easily transported and set up in practically any location. The unit can be towed by a tractor-trailer truck, or transported by rail or air to any location.

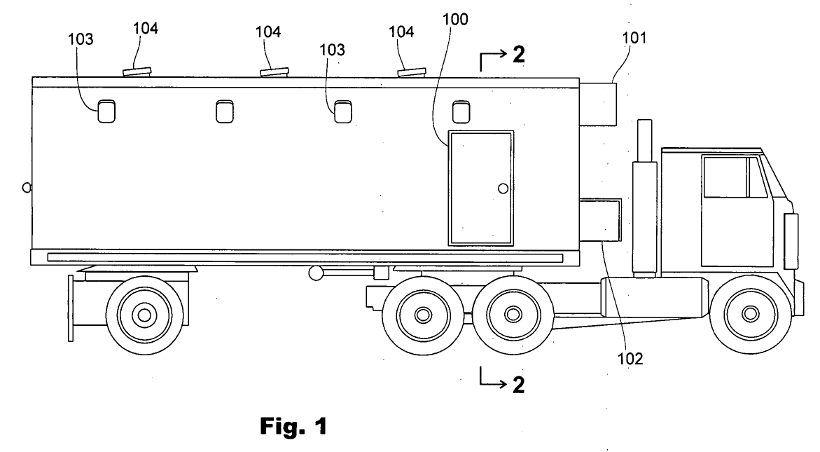

The side view of FIG. 1 shows a standard 28-foot tractor-trailer attached to Class 7 tractor. In this embodiment, a standard tractor-trailer unit is modified to create the mobile sleeping unit. The exterior modifications include an entrance door 100, an air conditioner 101, a generator 102, side windows 103 and roof ventilation/lighting units 104. The generator could be powered by gasoline and could be used to supply electricity for the air conditioning unit, power for electric heaters, power to the refrigerator and cooking appliances and power for lighting. In addition, the generator can be used for recharging emergency equipment such as lights and radios, if the mobile sleeping unit is being utilized for emergency operations, such as a forest fire.

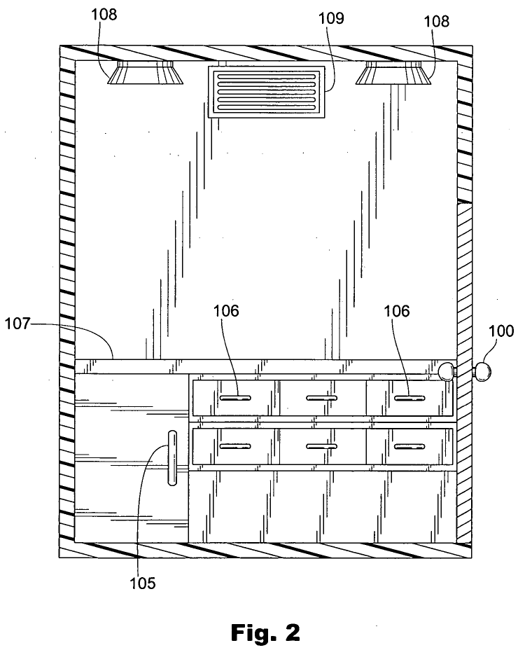

FIG. 2 shows a food storage/kitchen area of the embodiment shown in FIG. 1. In this configuration, the storage/kitchen area is located along the front wall of the interior of the tractor-trailer. A variety of different configurations may be utilized for this area, but in the embodiment shown, the storage/kitchen area includes a refrigerator 105 and storage drawers 106 and a countertop 107. Also shown on FIG. 2 are overhead fluorescent lights 108, an air conditioning vent 109 and the entrance door 100. Other possible configurations for the storage/kitchen area could include water coolers, wall-hung storage cabinets, electrical outlets, microwave ovens, and other common food preparation items.

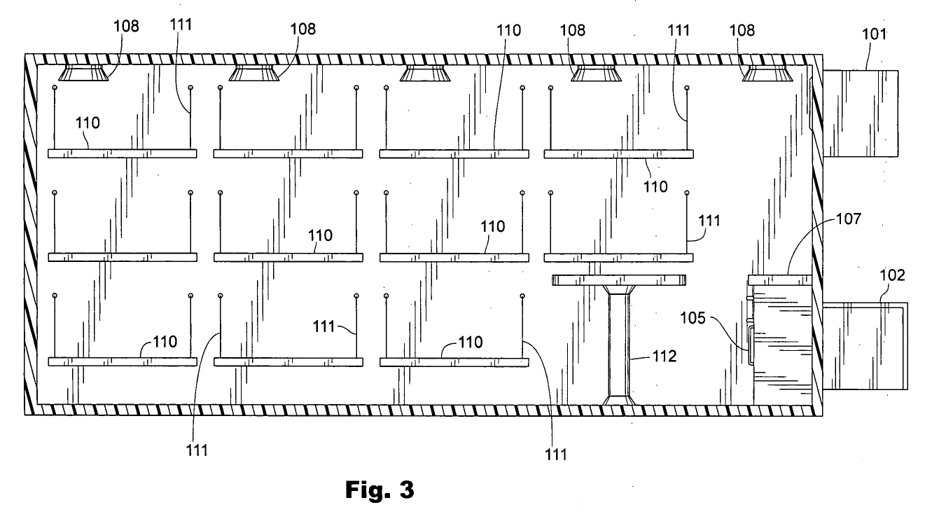

FIG. 3 shows an interior side view of the embodiment shown in FIG. 1. FIG. 3 shows one possible layout for the sleeping bunks. In this embodiment, the sleeping bunks 110 would be attached to the sidewall of the unit, efficiently utilizing the available space. The bunks are attached on one side to the trailer wall, and supported on the other side by cables 111 which attach to the trailer wall. The side of the bunk attached to the trailer wall is hinged, allowing the bunk to be lifted up and placed flat against the wall. This opens up the interior of the unit during daylight hours, allowing the unit to be used as a changing area, command base, lunchroom or rest area. In a standard 28-foot tractor-trailer, four columns of bunks could be placed along the wall, with up to three bunks in each column. The bunks can be placed along each sidewall of the trailer, giving a total of 24 bunks. In the embodiment shown in FIG. 3, one bunk on each sidewall has been removed in order to allow for the addition of a small table 112. The table could be utilized for meals, meetings or as a place to reviews maps and drawings.

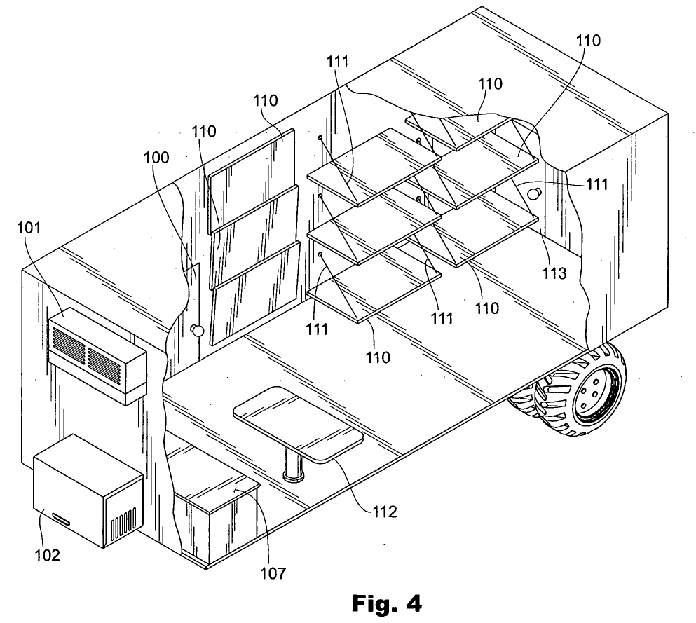

FIG. 4 shows a perspective view of the mobile sleeping unit, with roof being left off for reasons of clarity. This figure shows how the sleeping bunks 110 may be raised and secured to sidewall to open up space in the unit. In the embodiment shown in FIG. 4, the mobile sleeping unit would have three columns of bunk beds on the back wall with three beds in each column. Additional columns of beds would be on the opposite wall of the unit (not shown). The embodiment shown in FIG. 4 also shows a rear entrance door 113, similar to the side entrance door 100, shown in both FIGS. 1 and 4. The rear entrance door is not required, and a standard door for a 28-foot tractor-trailer could be utilized. If a standard door is used, the sleeping unit could more easily be used as a transport unit, to move equipment and supplies to the emergency site. The equipment and supplies could then be removed, allowing use of the unit as a sleeping unit.

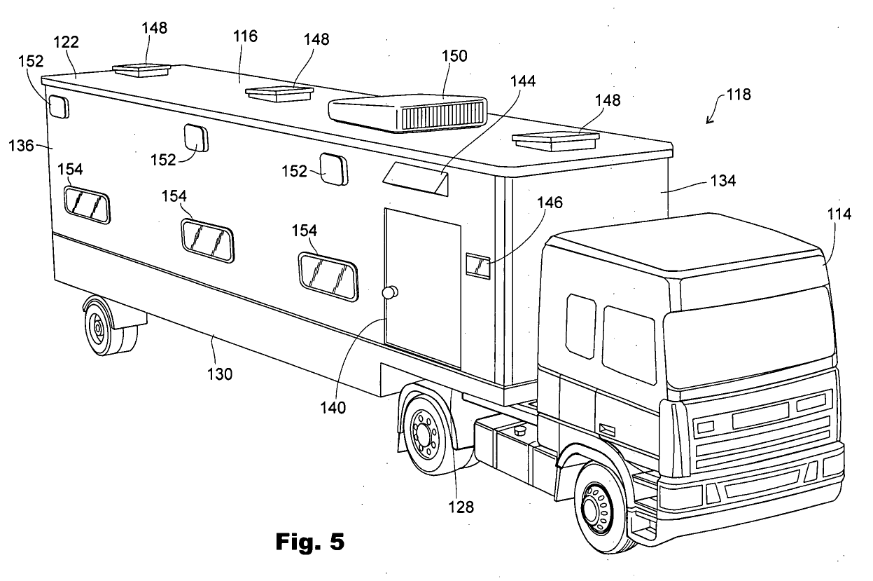

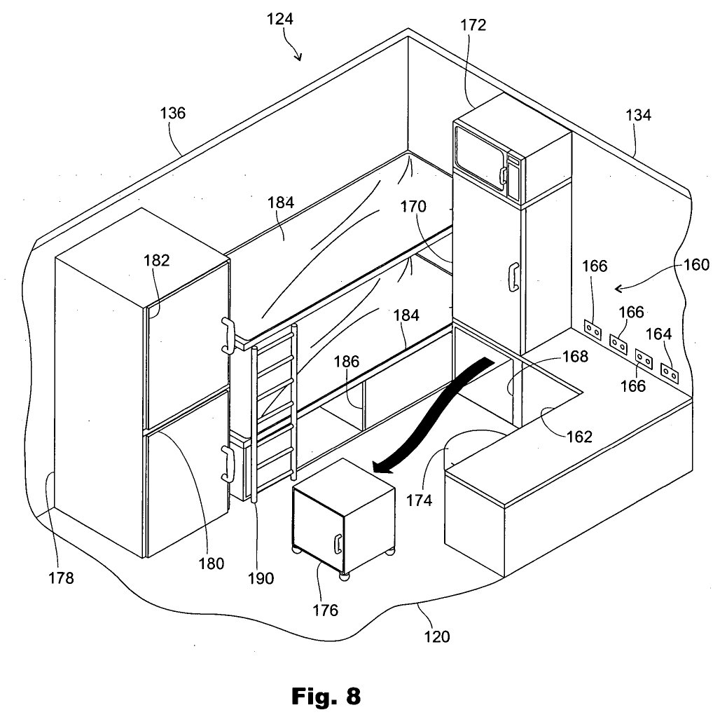

Illustrated in FIGS. 5-8 is an alternative embodiment of the mobile sleeping unit for attachment to and towing behind a tractor-trailer truck 114 as shown in FIG. 5. The mobile sleeping unit 116 of FIGS. 5-8 utilizes the features and elements of the mobile sleeping unit of FIGS. 1-4, but includes numerous conversion features as will be hereinafter explained. The emergency mobile sleeping unit 116 of FIGS. 5-8 incorporates the basic features of the mobile sleeping unit shown in FIGS. 1-4, but also includes a number of conversion features that greatly expand its utility and flexibility. The emergency mobile sleeping unit 116 of FIGS. 5-8 includes numerous conversion features or aspects pertaining to safety, the structural shell, the interior sleeping arrangements, workspace and amenities, communications, lighting and electrical service, temperature control and air circulation, power source, and miscellaneous and optional features.

The emergency mobile sleeping unit 116 comprises a trailer 118 attachable to and towable by the tractor-trailer truck 114. The trailer 118 includes the preferred dimensions of a width of eight feet, a length of 28 feet six inches, and a distance of nine feet from a main floor 120 to a roof 122. Furthermore, from the roof 122 of the trailer 118 to the ground is 13 feet two inches. The trailer 118 is divided into two main sections or portions, specifically, a general sleeping quarters 124 located at the rear portion of the trailer 118 and an office and bunk area or portion 126 located at the front portion of the trailer 118. A deck section 128 further delineates the front portion of the trailer 118, and the office and bunk area 126 are located at the deck section 128. The deck section 128 comprises approximately nine feet of the length of the trailer 118, and the frame or underside 130 of the trailer 118 drops 14 inches thereby defining a dividing line or line of transition between the deck section 128 and the remaining rear portion of the trailer 118 where the general sleeping quarters 124 are located. The drop-off from the deck section 128 to the general sleeping quarters 124 allows the trailer 118 to maintain a lowest workable center of gravity when the unit 116 is being towed or in use. In addition, the trailer 118 includes a rear wall 132, an opposite front wall 134, and a pair of sidewalls 136. Furthermore, the roof 122, sidewalls 136, front wall 134 and rear wall 132 are preferably composed of a white-painted aluminum sheeting over the steel frame chassis thereby meeting all DOT and OSHA structural material requirements. The sidewalls 136, front wall 134, rear wall 132 and roof 122 are insulated to the full depth of the upright and ceiling structural members and all walls 132, 134, and 136 and the roof 122 are covered in washable, waterproof insulated fiberglass sheet board. The floor 120 is covered with a washable, waterproof non-corrosive rubber anti-fatigue flooring material.

As shown in FIGS. 5-8, a 32 inch rear access door 138 is located on the rear wall 132 of the trailer 118, and a 32 inch front side access door 140 is located on one sidewall 136 adjacent the deck section 128. The front side access door 140 opens up to the office and bunk area 126 of the trailer 118. Retractable steps 142 are disposed under the deck section 128 and can be extend, slid or pulled out for allowing easy access to and use of the front side access door 140. The retractable steps 142 can be manually pulled out or operated through a mechanical power slide out mechanism, and the steps 142 can also include a collapsible grab rail 143. Exterior lighting will include at least one porch light 144 located above the front side access door 140 and curbside high intensity area lighting. The roof 122 of the trailer 118 includes several features that enhance both the safety and the temperature control and air circulation of the trailer 118. A small galley window 146 (preferably having the dimensions of 12 inches by 18 inches) is located at the office and bunk portion 126 of the trailer 118 to provide exterior light and ventilation to anyone working in the office/bunk area 126, but the galley window 146 can't be used as an emergency egress window because of the location of items and furnishings in the office and bunk area 126 hereinafter further explained (emergency egress will be through the front side access door 140 instead). Specifically, at least three roof escape hatches/skylights 148 are mounted to the roof 122 and can be used for ventilation and for allowing workers to exit and escape from the trailer 118 through the escape hatches/skylights 148 onto the roof 122. In addition, also mounted on the roof 122 is a low profile heating and cooling unit 150 that is preferably a roof air conditioner and furnace. The heating and cooling unit 150 is powered from an onboard power source hereinafter further explained. Ventilation is additionally provided by a plurality of spaced-apart sidewall vents 152 that are located on each sidewall 136 and at the upper portion of each sidewall 136. The sidewall vents 152 are adapted for manual crank out and retraction as desired to obtain the desired fresh air circulation.

A primary safety feature of the emergency mobile sleeping unit 116 of FIGS. 5-8 are a plurality of pop-out escape windows 154 spaced along each sidewall 136, and, further, spaced along the general sleeping quarters portion 124 of the trailer 118. The pop-out escape windows 154 are located at the lower portion of each sidewall 136, and the preferred dimensions for each escape window 154 is 19 inches in height by 29 inches in length. The emergency mobile sleeping unit 116 of FIGS. 5-8 includes at least seven pop-out escape windows 154, with three escape windows 154 located on one sidewall 136 (the sidewall 136 including the front side access door 140), and four escape windows 154 located on the opposite sidewall 136. To exit from the trailer 118, and to gain access to the trailer 118, when all other means fail, the escape windows 154 can be pushed out to gain access to the interior of the mobile sleeping unit 116, and to allow workers to quick egress and escape therefrom as a last resort.

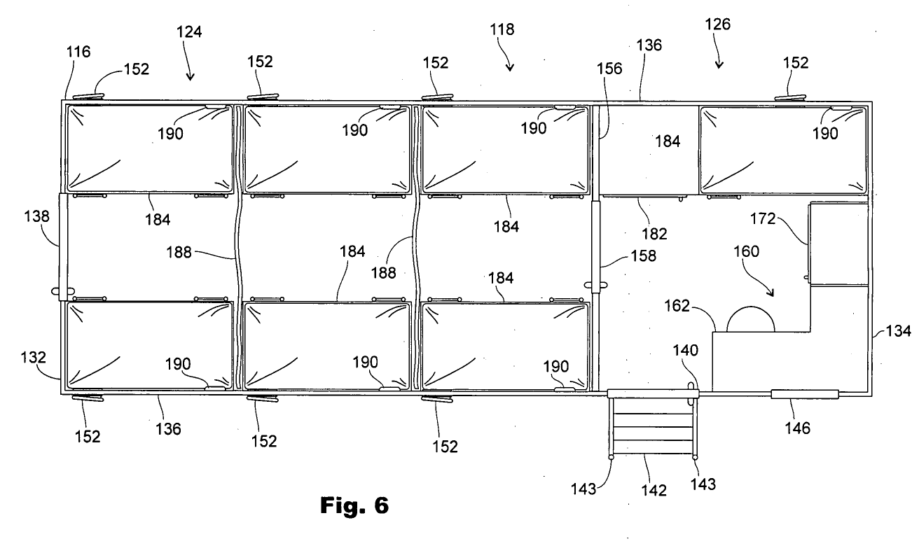

As shown in FIGS. 6-8, the emergency mobile sleeping unit 116 includes a range of features that enhance the applications of the mobile sleeping unit 116 and augment the comfort and safety of individuals using and working in the mobile sleeping unit 116. For example, the office and bunk area 126 is physically separated from the general sleeping quarters 124 by a divider wall 156. The divider wall 156 includes an access door 158 so that individuals can enter and exit the general sleeping quarters 124 and the office and bunk area 126. The divider wall 156 provides for quiet and privacy for anyone using or sleeping in the general sleeping quarter's area 124.

The office and bunk area 126 includes a number of features and equipment for working, eating, dining and communications. Thus, as shown in FIGS. 6-8, the office and bunk area 126 includes a workspace station 160 that comprises an 1-shaped counter top 162 for supporting thereon laptops, telecommunications devices, copiers, and facsimile machines and appropriate connections, ports and jacks for such laptops, printers, copiers, and facsimile machines. Overhead storage will be provided as well as GFCI outlets 164 and premium cable grade outlets 166 supporting, for example, CAT5E UTP cable connections. This type of cable connection will permit the mounting of a satellite receiver unit on the roof 122 of the trailer 118 that can be tied into and interconnected with wide area network (WAN) laptop ports utilizing the CAT5E UTP cable. Such communications will provide reliable contact with relevant government agencies such as FEMA. Adjacent to the counter top 162 work station is a generator cabinet 168, and placed upon the cabinet 168 is refrigerator 170 with a microwave oven 172 resting upon the refrigerator 170. The workstation 160 will also include such items as a pull-down map, one or more chairs 174, and depending on specific customer requirements and requests, such items as a water cooler, a coffee maker, a white board, or a corkboard. The power-using equipment requires 110-volt electricity that is supplied from a diesel-fired generator 176 mounted on a rollout base and stored within the generator cabinet 168. The generator 176 will roll out directly to the front side access door 140. Fuel for the generator 176 will be readily available from refueling trucks that are typically dispatched on site as part of the emergency/rescue operation. If refueling trucks are unavailable, fuel for the generator 176 could be taken or siphoned from the truck 114 used to tow the emergency mobile sleeping unit 116. A separate fuel-carrying vehicle could then be sent for refueling the truck 114. Opposite of the front side access door 140 is a double coat closet 178 having a lower closet section 180 and an upper closet section 182. The generator 176 would thus be electrically interconnected with and supply power to such items and features as the various types of communications equipment, the heating and cooling unit 150, the various interior and exterior lights, computers and laptops, and the refrigerator 170 and microwave oven 172.

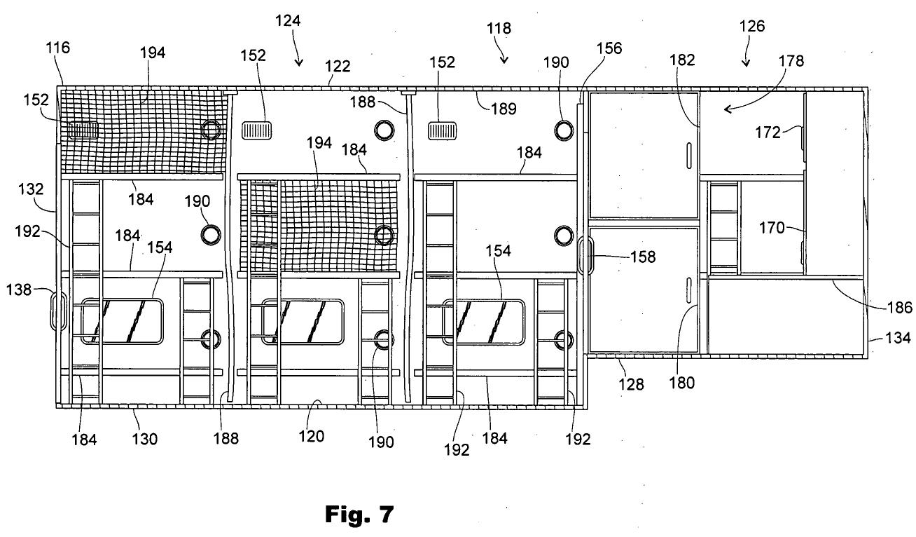

Both the office and bunk area 126 and the general sleeping quarters 124 include a number of steel frame twin flip up bunks or beds 184 that are mounted to the sidewalls 136 of the trailer 118. The flip up bunks 184 fold up against the sidewalls 136 when not in use and when floor space is needed for the storage of additional equipment and for moving equipment about the trailer 118 and to and from the trailer 118. The flip up bunks 184 preferably measure 32 inches wide by 72 to 74 inches in length and the bunks 184 can be adapted for lateral adjustment. The office and bunk area 126 includes one pair of flip up bunks 184 mounted to the sidewall 136 and between the double coat closet 178 and the refrigerator 170. A built-in storage cabinet 186 is located beneath the pair of flip up bunks 184 located in the office and bunk area 126. At least eighteen flip up bunks 184 are located in the general sleeping quarters 124 of the trailer 118. In the arrangement of FIGS. 6 and 7, nine flip up bunks 184 are mounted to one sidewall 136 and nine flip up bunks 184 are mounted to the opposite sidewall 136 with an aisle separating the flip bunks 184. The flip up bunks 184 in the general sleeper quarters 124 are further arranged along each sidewall 136 in three groupings with each grouping or layout including three columns of bunks 184 with each column having three bunks 184 stacked one above the other; or, alternatively, the arrangement of the bunks 184 can be viewed in the configuration of three rows of flip up bunks 184 with three flip up bunks 184 in each row. The flip up bunks 184 are shown in FIGS. 5-8 in their lowered or use position to accommodate resting, reclining or sleeping individuals; when folded up to the non-use position, the flip up bunks 184 would be disposed adjacent to and generally parallel and vertical with the respective sidewalls 136. The lowermost or first row of flip up bunks 184 are mounted to each sidewall 136 and are also located adjacent to the respective pop-out escape windows 154, and the second and third rows of flip up bunks 184 are arranged thereabove. At least one pair of privacy drapes 188 are hung from ceiling 189 and further separate each grouping or stacking of flip up bunks 184 so that three separate sleeping compartments within the general sleeping quarters 124 can be created. It should be noted that a flat, vertically-stacking bed or bunk can also be utilized that permits all the bunks to be raised to the ceiling area. A plurality of watertight wall reading lights 190 will be mounted to the respective sidewalls 136, and each wall reading light 190 will be mounted slightly above each flip up bunk 184. In addition, interior lighting will also be provided by at least four double watertight fluorescent ceiling units mounted to the ceiling and spaced therealong from the general sleeping quarters 124 to the office and bunk area 126.

As illustrated in FIGS. 6-8, a plurality of removable safety ladders 192 are used to facilitate and ease the access to and from the flip up bunks 184 of the second and third rows. In addition, one safety ladder 192 is disposed with the flip up bunks 184 located in the office and bunk area 126 of the emergency mobile unit 116. Each flip up bunk 184 also includes an accompanying safety cargo net 194 that stretches over each flip up bunk 184. The cargo nets 194 are attached to the respective sidewalls 136 and the respective flip up bunk 184 for covering that bunk 184. The cargo net 194 is stretchable to accommodate the folding down and folding up of each bunk 184, and each cargo net 194 stretches over the open area of each bunk 184 thereby containing the individual laying or resting on the bunk 184 and thus providing a safety feature that prevents the individual from rolling off the bunk 184. In addition, each cargo net 194 allows the individual to place or store items or cargo on the bunk 194 without the worry that the items or cargo will roll or fall off the bunk 184. For illustrative clarity cargo nets 194 are shown extending on and covering two flip up bunks 154 in FIG. 7, but each flip up bunk 154 would have one cargo net 194.

Additional safety features will include at least two carbon monoxide detectors, two number 5 fire extinguishers, and at least three smoke detectors all mounted for ready use and optimal detection and positioned about the general sleeping quarters 124 and the office and bunk area 126. The emergency mobile sleeping unit 116 will also include standard warning stickers and seals such as the RVIA required warning sticker and the RVIA Standards Seal. RVIA standards will be attained so that the emergency mobile sleeping unit 116 can be contracted for use by FEMA. In addition, the emergency mobile sleeping unit 116 will meet the various standards required by both DOT and OSHA regulations. Finally, as the purpose of the emergency mobile sleeping units of FIGS. 1-8 is to provide rest and rejuvenation for fatigued emergency medical personal, workers, fire fighters, law enforcement personal, military personnel, disaster relief crews, etc., other amenities and features may include an exterior awning to reduce heat within the trailer 118 and to provide shade for workers resting and reclining outside of the trailer 118 on durable, fold-up metal frame canvas outdoors chairs that can be stored within the trailer 118 when not being used.

Having thus described certain embodiments of the present invention, various alterations, modifications and improvements will be apparent to those of ordinary skill in the art. The alterations, modifications and improvements are intended to be within the spirit and scope of the present invention. Accordingly, the above descriptions are only intended as examples, and are not intended to be limiting.

I claim:

1. An emergency mobile sleeping unit, comprising:
an elongated trailer having a front wall, a rear wall, a pair of opposed sidewalls, a roof, a ceiling and a floor;
the trailer being divided into an office and bunk area and a general sleeping quarters with a divider wall separating the office and bunk area from the general sleeping quarters;
a plurality of pop out escape windows located on each sidewall and capable of being pushed out to allow access to and egress from the office and bunk area and the general sleeping quarters area;
a double coat closet located in the office and bunk area;
a refrigerator located in the office and bunk area;
a microwave oven resting upon the refrigerator and located in the office and bunk area;
a generator cabinet located within the office and bunk area;
a generator stored within the generator cabinet for providing power for the emergency mobile sleeping unit;
a plurality of flip up bunks disposed within the general sleeping quarters and mounted to each sidewall with each flip up bunk capable of being disposed to a use position and a folded up position;
the flip up bunks mounted to each sidewall being arranged in three rows of flip up bunks with the flip up bunks of the lowermost rows being located adjacent to the pop out escape windows;
a plurality of cargo nets with each cargo net extending over and covering one flip up bunk when that respective flip up bunk is folded out to the use disposition;
a plurality of removable safety ladders for disposition adjacent to the flip up bunks for providing easy access to the flip up bunks; and
a plurality of privacy drapes mounted to the ceiling and pendent therefrom for further dividing the general sleeping quarters into at least three separate sleeping compartments.

2. The emergency mobile sleeping unit of claim 1 further comprising a deck section at the front of the trailer and which accommodates the office and bunk area.

3. The emergency mobile sleeping unit of claim 2 further comprising a front side access door located on one sidewall and adjacent the deck section of the trailer.

4. The emergency mobile sleeping unit of claim 3 further comprising a rear access door located on the rear wall and providing access to the general sleeping quarters.

5. The emergency mobile sleeping unit of claim 4 further comprising retractable steps mounted to the deck section and below the front side access door for extension from the deck section to facilitate use of the front side access door and retraction thereunder when the front side access door is not being used.

6. The emergency mobile sleeping unit of claim 5 further comprising a heating and cooling unit that is mounted to the roof of the trailer for heating and cooling the office and bunk area and the general sleeping quarters.

7. The emergency mobile sleeping unit of claim 6 further comprising a plurality of sidewall vents mounted to the sidewalls of the trailer for providing ventilation and air circulation within the office and bunk area and the general sleeping quarters.

8. An emergency mobile sleeping unit, comprising:
an elongated trailer having a front wall, a rear wall, a pair of opposed sidewalls, a roof, an underside, a ceiling opposite the roof, and a floor;
the trailer being divided into an office and bunk area and a general sleeping quarters section with a divider wall separating the office and bunk area from the general sleeping quarters section;
a plurality of pop out escape windows located on each sidewall and capable of being pushed out to allow egress from the general sleeping quarters section and the office and bunk area;
a generator cabinet located within the office and bunk area;
a generator for storage within the generator cabinet for providing power for the emergency mobile sleeping unit;
a plurality of flip up bunks disposed within the general sleeping quarters section and mounted to each sidewall with all the flip up bunks capable of being disposed to a use position and a non-use position that is adjacent the respective sidewalls;
the flip up bunks mounted to each sidewall so that they are arranged in three rows with the flip up bunks arranged on a lowermost row being located adjacent to the pop out escape windows;
a plurality of cargo nets with each cargo net extending over and covering one flip up bunk when that respective flip up bunk is folded out to the use position;
a plurality of removable safety ladders for disposition adjacent to the flip up bunks for providing easy access to the flip up bunks; and
at least two privacy drapes mounted to the ceiling and pendent therefrom for further dividing the general sleeping quarters section into at least three separate sleeping compartments.

9. The emergency mobile sleeping unit of claim 8 further comprising a double coat closet that is located in the office and bunk area.

10. The emergency mobile sleeping unit of claim 9 further comprising a refrigerator that is located within the office and bunk area and powered from the generator.

11. The emergency mobile sleeping unit of claim 10 further comprising a microwave oven that is disposed upon the refrigerator and powered from the generator.

12. The emergency mobile sleeping unit of claim 11 further comprising a front side access door located on one sidewall and a rear access door located on the rear wall and providing access to the general sleeping quarters section.

13. The emergency mobile sleeping unit of claim 12 further comprising a plurality of retractable steps mounted adjacent the office and bunk area and below the front side access door for selective extension from the underside of the trailer to facilitate use of the front side access door and retraction under the underside of the trailer when the front side access door is not in use.

14. The emergency mobile sleeping unit of claim 13 further comprising a heating and cooling unit that is mounted on the roof of the trailer for heating and cooling the office and bunk area and the general sleeping quarters section.

15. The emergency mobile sleeping unit of claim 14 further comprising a plurality of sidewall vents mounted to each sidewall for providing ventilation and air circulation to the office and bunk area and the general sleeping quarters section.

16. An emergency mobile sleeping unit, comprising:
an elongated trailer having a front wall, a rear wall, a pair of opposed sidewalls, a roof, an underside, a ceiling opposite the roof, and a floor;
the trailer being divided into an office and bunk area and a general sleeping quarters with a divider wall separating the office and bunk area from the general sleeping quarters;
a plurality of pop out escape windows located on each sidewall and capable of being pushed out to allow egress from the office and bunk area and the general sleeping quarters;
a double coat closet located in the office and bunk area;
a refrigerator located in the office and bunk area;
a microwave oven for disposition upon the refrigerator;
a workspace station located in the office and bunk area and including GFCI outlets and cable connections;
a generator cabinet located within the office and bunk area;
a generator for storage within the generator cabinet for providing power for the emergency mobile sleeping unit;
a plurality of flip up bunks disposed within the general sleeping quarters and mounted to each sidewall with each flip up bunk capable of being disposed to a use position and to a non-use folded up position;
the flip up bunks being mounted to each sidewall so that they are arranged in three rows extending along the respective sidewalls with the flip up bunks in a lowermost row being located adjacent to the pop out escape windows;
a plurality of wall reading lights mounted to each sidewall and each wall reading light being located above the respective flip up bunk;
a plurality of cargo nets with each cargo net extending over and covering one flip bunk when that respective flip up bunk is folded out to the use position;
a plurality of removable safety ladders for disposition adjacent to the flip up bunks for providing easy access to the flip up bunks; and
a plurality of privacy drapes mounted to the ceiling and pendent therefrom for further dividing the general sleeping quarters into at least three separate sleeping compartments.

17. The emergency mobile sleeping unit of claim 16 further comprising a heating and cooling unit that is mounted on the roof of the trailer for heating and cooling the office and bunk area and the general sleeping quarters.

18. The emergency mobile sleeping unit of claim 17 further comprising a plurality of retractable steps mounted adjacent to the office and bunk area and below the front side access door for selective extension from the underside of the trailer to facilitate use of the front side access door and retraction under the underside of the trailer when the front side access door is not being used.

19. The emergency mobile sleeping unit of claim 18 further comprising a plurality of sidewall vents mounted to each sidewall for providing ventilation and air circulation to the office and bunk area and the general sleeping quarters.

20. The emergency mobile sleeping unit of claim 19 further comprising a front side access door located on one sidewall and opening to the office and bunk area and a rear access door located on the rear wall for providing access to the general sleeping quarters and egress therefrom.
